(19) United States
(12) Patent Application Publication
(10) Pub. No.: US 2024/0104269 A1
(43) Pub. Date: Mar. 28, 2024

(54) TRANSFERABLE HYBRID PROGNOSTICS BASED ON FUNDAMENTAL DEGRADATION MODES

(71) Applicant: Palo Alto Research Center Incorporated, Palo Alto, CA (US)

(72) Inventors: Amirhassan Abbasi, Philadelphia, PA (US); Kai Frank Goebel, Mountain View, CA (US); Peetak P. Mitra, Palo Alto, CA (US)

(73) Assignee: Palo Alto Research Center Incorporated, Palo Alto, CA (US)

(21) Appl. No.: 17/946,826

(22) Filed: Sep. 16, 2022

(51) Int. Cl. G06F 30/27

(52) U.S. Cl. CPC G06F 30/27; G06F 2119/02

(57) ABSTRACT

A transferable hybrid method for prognostics of engineering systems based on fundamental degradation modes is provided. The method includes developing a degradation model that represents degradation modes shared in different domains of application through the integration of physics and machine learning. The system measures sensor signals and data processing provides for extracting health indicators correlated with the fundamental degradation modes from sensors data. For the integration of physics and machine learning, the degradation mode is separated into different phases. Before the accelerated degradation phase of a system, the method is looking out to detect when the accelerated phase begins. When accelerated phase is active, the system applies a machine-learning model to provide information on the accelerated degradation phase, and evolves the degradation towards a failure threshold in a simulation of the updated physics-based model to predict the degradation progression. The system estimates the remaining useful life of the target system.

### FIELD

This disclosure is about a transferable prognosis method and system for estimation of the remaining useful life of engineering systems. This model represents common fundamental degradation modes that are shared in many domains of application. Encapsulating these modes in prognostics enhances its transferability and adaptability to different domains of application.

### SUMMARY

The embodiments described herein provide a system and method for transferable prognostics based on developing a transferable degradation model. A primary component of prognostics is a degradation model that shows time variation of state of the health of the system. Such a model can be evolved toward a pre-defined end of life threshold for estimation of remaining useful life. In general, a degradation model encapsulates one or more degradation modes which represent different aspects of the health variation of the system. Each engineering system may undergo single or multiple degradation modes through the loading toward the end of life. Regardless of specifications of engineering systems at different domains of application, they may share similar degradation modes. These modes, which are called fundamental degradation modes in this disclosure, are unifying part of degradation over different domains and essence of developing a transferrable degradation model. The disclosed inventive method identifies, analyzes, and encapsulates these widely observed degradation modes in the prognostics reasoning with the aim of enhancing the transferability, adaptability, and ease of deployment.

In many engineering systems, direct development of such a degradation model is not trivial. Given the complexity, nonlinearity, and multi-dimensionality of systems, pure physics-based approaches for developing a degradation model maybe impractical. Also, the performance of data driven approaches is highly dependent on availability of historical data which hampers their application in different application domains where these data are not abundantly available. The present disclosure describes a hybrid prognostics method which combines advantages of data-driven and physics-based approaches to develop a transferable degradation model. FIG. 1A illustrates the general idea behind the current inventive method, in accordance with one embodiment. As can be seen in this example, block 11 represents n number of plants in different application domains that are monitored by a number of sensors (block 12) for condition assessment in each domain. The core part of the present inventive method is shown in block 15 where a hybrid transferable model represents fundamental degradation modes as α, β, and χ. These modes are commonalities between these domains which are encapsulated in the degradation model, even though not all of them may be shared by all applications. Each mode abstracts health variation of the system from an aspect and may manifest at different health stages of the system. The hybrid model can be interpreted as instantiation of fundamental modes which is developed by hybridization of physics and machine learning. To this end, as represented by block 14 in FIG. 1A, physics-based model and machine learning mapping are integrated appropriately based on condition of each domain. Hence, the objective of block 14 in each application domain is leveraging the physics and machine learning to develop a transferable degradation model. The machine learning model typically involves prior data-processing steps, which are represented in block 13, such as feature extraction from condition monitoring sensors data for transferring the observations to a space with high correlation with fundamental modes. These processing steps can be customized based on each domain of application condition. It should be noted that in domains in which a damage/degradation variable is directly observable the data-processing steps can be shorter than those in which the health variation is not directly observable from the sensory data. In such domains, the sensor data can be transformed to a health domain with the aim of extracting a health indicator with high correlation with fundamental degradation modes. Also, selection, development and deployment of machine learning modes can be performed based on quantitative and qualitative assessment of data in each domain. In block 14, type of physics-based models that are used at each hybridization steps can depend on balance between accuracy and simplicity of models in each domain. For example, in lithium-ion battery discharge progression prognostics, which is one example used in this disclosure, the physics-based models can be electrochemical models, multi-physics models, empirical models or molecular/atomist models. However, in more complex domains such as a turbo-fan engine, which is another example used in this disclosure, the physics-based models can be more abstract, for example by taking less consideration of micro-level processes and by focusing on macro-level degradation in an empirical form. Also, it should be noted that although the fundamental modes have similar representation in different domains, the root cause can be different. For example, in lithium-ion batteries the fundamental modes are mostly due to electrochemical process, while in turbo-fan engines the fundamental modes are mostly due to internal thermal or mechanical interactions such as friction or thermal stresses. In the block diagram shown in FIG. 1A, the physics-based model and machine learning model are two sources of information which can be leveraged to develop a hybrid model. Block 16 represents that time evolution of the hybrid model toward the end of life can be used for main prognosis tasks and remining useful estimation.

In a variation on this embodiment, with the aim of appropriate integration of physics-based model and machine learning each active mode of degradation may be separated into different phases. For example, the mode α (see block 15 in FIG. 1A) can be separated into three different phases. The first phase represents an initial wear, then a slow quasi-linear phase that is followed by an accelerated exponential phase. The quasi-linear phase propagation is relatively slower than the exponential phase. For the appropriate hybridization of physics and machine learning these phase transitions can be identified as well during the system operation. To this end, during operation, the system can measure signals via a set of sensors associated with the target system. Identification of different phases provides for appropriate hybridization of physics and machine learning. For example, in the case of α mode a physics-based model can be used in the second slow phase since degradation follows a quasi-linear pattern. Hence, in this case, in response to determining, based on the measured sensor signals that the slow phase is active in the target system, the system can process the measured sensor signals and calibrate and tune a physics-based model associated with the target system. On the other hand, in response to determining, based on the measured sensor signals, which indicate that the (accelerated) phase is active in the target system, the system can apply a machine-learning model to predict the degradation progression. The system can then perform, based on the machine learning model outputs, a time simulation of the updated physics-based model to start predicting the entire degradation pattern of the target system. The system can then estimate, based on the predicted degradation pattern, a remaining useful life of the target system.

In a further variation on this embodiment, an intersection of the predicted degradation pattern and an end-of-life threshold indicates an estimated end-of-life of the target system. The remaining useful life of the target system corresponds to the difference between a current time and the estimated end-of-life of the target system.

In a further variation on this embodiment, requirements for hybridization of physics and machine learning are proposed, for example for feature extraction. A method is described for extracting and for extracting invariant and degradation sensitive features.

In a variation on this embodiment, the target system can undergo single or combinational degradation modes. For example, the a mode can manifest in many target systems includes one or more of: a battery; a power storage device; a rotating machine; a chemical plant; an automotive component; a biomedical component; an aerospace component; a nuclear power component; a maritime component; a mining component; a medical equipment component; a manufacturing system component; a civil engineering related system; and an electrical engineering related system.

In a further variation on this embodiment, the system can apply a set of signal processing techniques to the measured sensor signals to obtain pre-processed sensor data.

In a further variation on this embodiment, the signal processing techniques include one or more of: data scrubbing; feature extraction; feature ranking; feature sensitivity analysis; feature reduction; feature fusion; and data transformation.

In a further variation on this embodiment, the system can perform elbow point detection, based on the measured sensor signals, to determine a transition point of active phases in a degradation mode. The transition point indicates a point at which a transition occurs in time rate of the degradation.

In a further variation on this embodiment, in response to determining, based on the measured sensor signals, that the target system is subject to a first loading cycle, the system can calibrate a set of parameters of a physics-based model associated with the target system.

### BRIEF DESCRIPTION OF THE FIGURES

FIG. 1A illustrates an exemplary block diagram for transferrable prognostics based on fundamental degradation modes, in accordance with an embodiment of the present application.

FIG. 1B shows an exemplary fundamental degradation mode associated with the a mode of degradation in FIG. 1A for a target system under constant load condition, in accordance with an embodiment of the present application.

FIG. 2 illustrates an exemplary transferable hybrid reasoning system architecture, in accordance with an embodiment of the present application.

FIG. 3 illustrates different data processing techniques, in accordance with an embodiment of the present application.

FIG. 4 illustrates interconnected requirements that are considered for integration of physics and machine learning, in accordance with an embodiment of the present application.

FIG. 5A shows an exemplary discharge trajectory that represents a fundamental degradation mode (a) with an elbow point and corresponding phases in a lithium-ion battery, in accordance with an embodiment of the present application.

FIG. 5B shows two exemplary discharge trajectories over two load cycles for a lithium-ion battery, in accordance with an embodiment of the present application.

FIG. 5C-1 and FIG. 5C-2 illustrate an algorithm for detecting an elbow point, in accordance with an embodiment of the present application.

FIG. 6A presents an exemplary physics-based model prognosis reasoning, in accordance with an embodiment of the present application.

FIG. 6B illustrates an algorithm for determining a numerical solution of a state space representation of a physics-based model, in accordance with an embodiment of the present application.

FIG. 6C illustrates the Levenberg-Marquardt algorithm for solving a minimization problem, in accordance with an embodiment of the present application.

FIG. 6D presents an exemplary machine learning model to provide information about the accelerated degradation mode, in accordance with an embodiment of the present application.

FIG. 7 shows an exemplary hybrid prognosis reasoning for predicting the entire degradation trajectory and a remaining useful life of a target system, in accordance with an embodiment of the present application.

FIG. 8 illustrates an exemplary hybrid reasoning system architecture with mutual coupling between physics-based model and machine learning model, in accordance with one embodiment of the present application.

FIGS. 9A-9C present a flowchart illustrating a process for performing hybrid reasoning based on physics and machine learning for prognostics, in accordance with one embodiment of the present application.

FIG. 10 illustrates an exemplary computer system that facilitates hybrid reasoning based on physics and machine learning for prognostics, in accordance with one embodiment of the present application.

In the figures, like reference numerals refer to the same figure elements.

### DETAILED DESCRIPTION

The following description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown but is to be accorded the widest scope consistent with the principles and features disclosed herein.

### Overview

Rapid development and advancement in science and technology in a broad range of fields, e.g., aerospace, agriculture, automotive, biomedical, civil, robotics, manufacturing, electronics, and computers, have triggered demands for efficient prognostics and health management strategies. The primary goals are maximizing the productivity, reliability, maintainability, and safety of the systems and minimizing the downtime and operational costs.

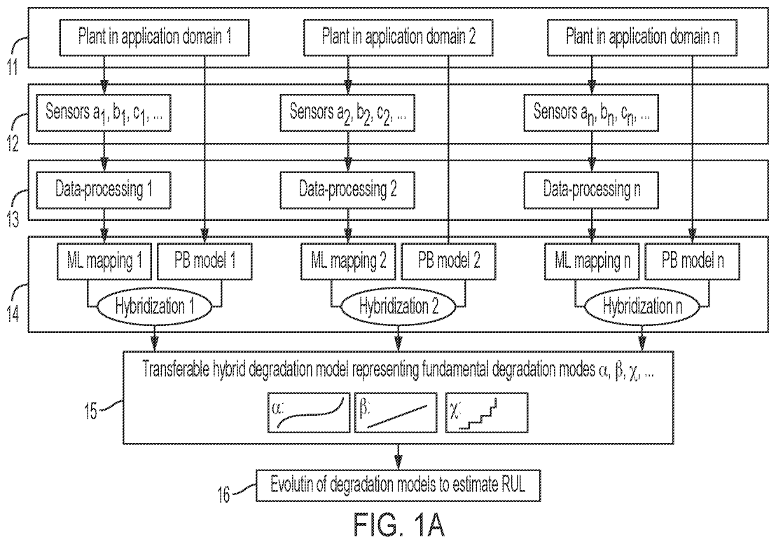

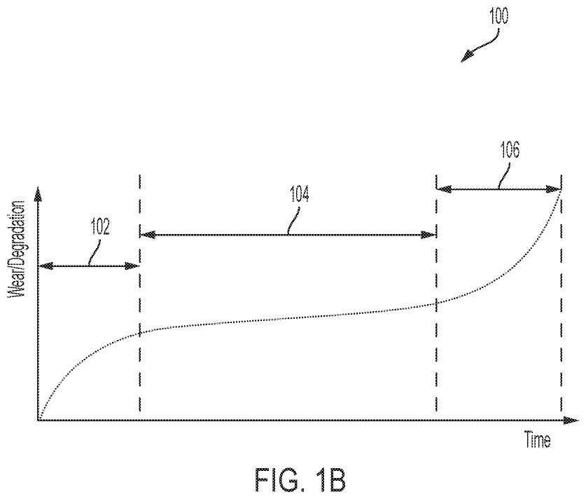

The overall design of the prognostics and health management strategies involves elements for monitoring of equipment through sensors, and analysis of the sensor measurements to arrive at system health assessment and prediction of remaining equipment life. The complexity of the systems in different engineering fields and depending on the application domain, operator requirements, physical and practical limitations, and priorities have resulted in designing domain (or component) specific prognostics and health management strategies. Such design considerations can result in different specifications for different domains of applications which can adversely affect the adaptability of the prognostics strategies and limit their application range. However, irrespective of the domain or target system specifications, the target system, i.e., the system for which system prognostics and health management strategies are being designed, may share some generic and high-level similarities with respect to the fault progression, one can take advantage of these similarities. For example, similar modes of degradation can be observed in a number of engineering systems. Developing degradation models based on these shared degradation modes, which are referred to as fundamental modes in this disclosure, highly enhances transferability of prognostics reasoning. For example, FIG. 1A shows a common degradation mode that can be observed in many domains, e.g., subtractive manufacturing assets like drilling machines, milling machine inserts and lathes, bearings in rotating equipment, or even lithium-ion batteries in power storage systems. These systems all follow a typical degradation mode.

The changing health condition of a system can be reflected in changes of sensor observations with the progression of degradation over time. Based on the root cause of the degradation of a system, the degradation can be divided into different fundamental modes. The evolution of each mode is encapsulated in its own prognostic assessment. Regardless of specifications and differences of engineering systems, these systems may undergo similar degradation modes. Identifying the shared degradation modes and developing a degradation model which represents these modes is the core idea of the current invention, which provides a transferable prognostics method. Such a method can provide for high adaptability of knowledge with low deployment cost.

Some of the embodiments described in the present application solve the technical problem of estimating the remaining useful life of engineered systems, subsystems, assets, and components by developing a degradation model based on fundamental degradation modes. The model development is achieved by hybridization of physics and machine learning. Specifically, the proposed prognostics method can leverage the strengths of both the data-driven and physics-based modeling while avoiding some of the shortcomings.

For appropriate integration of physics and machine learning, the system should extract and determine domain specific and domain invariant model inputs which are robust and informative about the health condition and degradation progression. Based on invariant inputs the transferable hybrid reasoning system (hereinafter “system”) can make a smooth coupling between physics-based and machine learning models. The hybridization of physics and machine learning in the proposed prognostics method can result in overcoming challenges associated with both training data scarcity and incomplete knowledge of faults and their progression in physics-based modeling.

As discussed earlier, many engineering systems share similar degradation modes. For example, prognostics of discharge for lithium-ion batteries is taken into consideration, in which the discharge trajectory follows the fundamental degradation mode which will be explained in the next section. Also, to clarify the transferability of approach to different domains a turbo-fan engine system prognostics is studied as well. It should be noted that the hybrid reasoning system can be applied to other domains of application or use cases which undergo a degradation with similar fundamental modes after necessary modifications. For example, other domains of application can include and is not limited to rotating machines (e.g., turbines), power storage devices, chemical plants, aerospace components, nuclear power components, maritime components, mining components, medical equipment components, manufacturing systems components, automotive components, biomedical components, civil engineering related systems, electrical engineering related systems, etc.

### Degradation Modes

FIG. 1B shows the most common fundamental degradation mode (noted by a in FIG. 1A) for a target system under constant load condition, in accordance with an embodiment of the present application. In the example shown in FIG. 1B, the degradation pattern 100 can be characterized into three types of degradation phases which can include an initial transient wear phase 102 (showing a rapid initial drop in health or a corresponding rise in degradation) which may not be observable in some systems, a slow quasi-linear degradation progression phase 104, and an accelerated exponential degradation phase 106 towards an end-of-life of the target system under consideration. The generic fundamental degradation mode 100 depicted in FIG. 1B can be observed in a wide range of engineering systems, e.g., in voltage discharge of lithium-ion batteries, in subtracting manufacturing like drilling machines, milling machines inserts, lathes, and bearings in rotating equipment.

In one embodiment, a transferable hybrid reasoning system can analyze and incorporate the degradation mode 100 into the hybrid degradation model development and provide a generic framework that can be adapted to different assets/systems upon necessary modifications or tuning.

In order to develop a degradation model that represents fundamental degradation modes using only a data-based approach or only a physics-based prognostics approach can be difficult. This is because applicability of physics-based approaches may be limited for many reasons, e.g., the knowledge about the physics of faults, failures, and progression associated with the target system can be incomplete. Such physics-based models may be inaccurate and/or complex, which means that considerable effort would have to be undertaken to encapsulate the underlying physics into a mathematical model where the magnitude of the effort does not justify the benefit of end-of-life prediction.

Data-driven algorithms may suffer from lack of sufficient historical data for training the algorithms, which can cause inability of data-driven algorithms to generalize and predict the progression of faults. In addition, it may be impractical or cost prohibitive to deploy a large number of sensors for adequate data collection.

Some of the embodiments described in this application can be used to develop a hybrid transferable degradation model that represents fundamental degradation modes 100 and estimate the corresponding remaining useful life of the target system by integrating physics-based model and machine learning model. The idea behind hybridization of physics and machine learning is to encapsulate the physics of the root cause of fundamental degradation modes and to provide a data-driven transfer function that maps sensor signals to a health domain which includes the fundamental degradation modes.

In another embodiment of the present application, requirements are set for appropriate hybridization of physics and machine learning. To do so, each fundamental degradation mode maybe separated into different phases. The length of this phase can be at different time scales in different domains. A main goal is to identify, analyze, and follow these phases regardless of their time order. Detailed description about meeting this goal through integrating physic and machine learning is provided in the following sections. Another important aspect is using robust inputs. Such inputs can be extracted from fundamental and long-lasting aspects of the fault progression.

### System Architecture for Transferable Hybrid Reasoning System

One embodiment of the present application provides a transferable hybrid system for developing a degradation model which represents fundamental degradation modes. Through the model development the generic, robust, and interpretable representation of physics of degradation is leveraged with machine learning ability that provides a complex mapping from sensor data to a health domain including degradation modes. Thus, the hybrid transferable degradation model provides for customized coupling between physics-based model and machine learning model to estimate the remaining useful life of a target system.

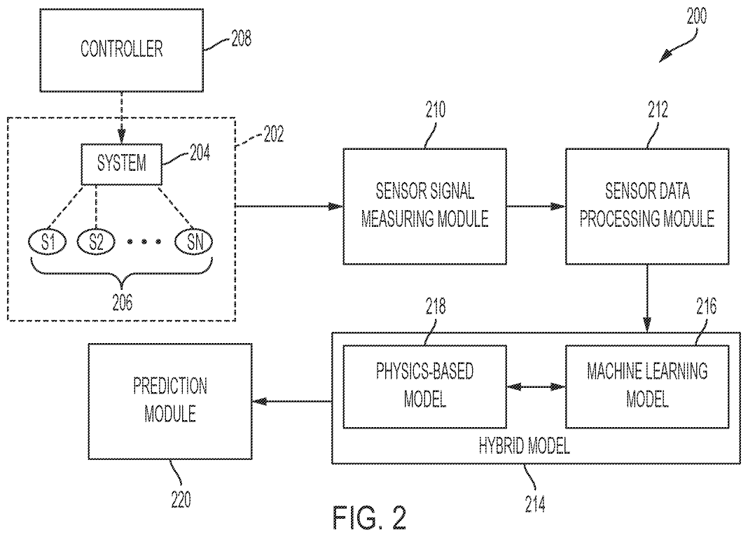

FIG. 2 illustrates an exemplary transferable hybrid reasoning system architecture, in accordance with an embodiment of the present application. In the example shown in FIG. 2, system architecture 200 can include a target system 204 (or subsystems, assets, and components) with multiple sensors 206 attached. Sensors 206 can measure one or more attributes of target system 204. For example, the sensors can be associated with a wide range of measurement components which can include and are not limited to temperature, acceleration, strain, force, pressure, current, displacement, vibration, force, etc. Sensors 206 can be deployed in places where the probability of extracting information associated with the potential fault is high.

For example, with the deployment of sensors 206 in certain relevant locations, system 200 may identify information in sensor signals or raw data that provide an indication about the health of target system 204. In other words, system 200 may extract certain features from the sensor signals that are informative about health condition, faults, and their progression in the target system. The system may also combine information from different sensor readings which can be directly or indirectly related to the health of target system 204.

Monitored system 202 can represent target system 204 monitored via a set of sensors 206. For example, to identify a certain type of abnormality, fault, outage, or failure caused by an equipment malfunction, system 200 may measure and monitor sensor readings that provide information about the equipment or target system 204. Sensors 206 may capture information about nominal operation of target system 204, a change from nominal operation to abnormal operation, and then a change to a state where target system 204 is no longer working according to a functional specification or performance metric, e.g., unable to produce a part that satisfies a certain quality criterion. Target system 204 might undergo degradation which will be reflected in observations/sensor data as fundamental modes (fundamental mode 100 shown in FIG. 1B) as time passes and loading is continued. Controller 208 can determine a loading profile or loading distribution applied to target system 204 over a time range that can be defined by a user of system 204. The loading distribution can be based on user preferences which can result in setting a usage level of target system 204. Specifically, controller 208 can determine a time rate of the target system's usage.

System architecture 200 can further include a sensor signal measuring module 210 for measuring and recording the sensor signals from set of sensors 206. Sensor signal measuring module 210 can perform data acquisition for collecting monitored sensor signals by managing the sensor equipment. In other words, sensor signal measuring module 210 can measure with sensors 206 and record measurement updates based on observations from target system 204 which can be used for estimating a state of target system 204 and for performing prognosis. Module 210 can design data acquisition based on practical constraints of target system 204 such as weight, sensitivity, power demands, volume, and cost of sensor deployment for target system 204 in different domains of application, e.g., aerospace, industrial machines, and infrastructure.

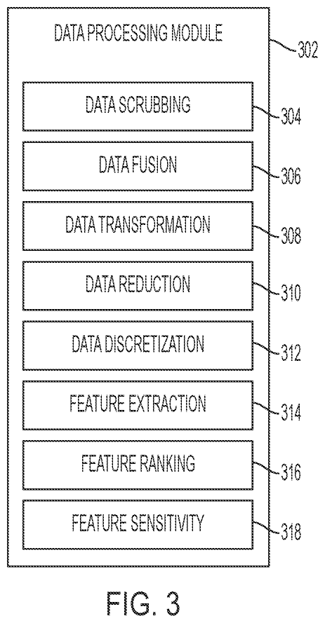

Sensor data processing module 212 can perform different data processing operations on the sensor signals and provide the processed data to a hybrid model 214. Sensor data processing module 212 can further save the processed data in computer data storage(s) in a tractable format for further processing. The different data processing operations are described below with reference to FIG. 3.

Hybrid model 214 can optimally hybridize a machine-learning model 216 and a physics-based model 218 to perform a hybrid reasoning about the health of target system 204. The hybridized model can operate on the pre-processed data from sensor data processing module 212. Based on the output of hybrid model 214, prediction module 220 can perform prognostics and estimate a remaining useful life of target system 204. The remaining useful life (RUL) can be defined as an estimate of the amount of time target system 204 will be able to perform its expected task. During this estimated time, performance metrics of target system 204 will be better than those at end-of-life threshold. In an engineering sense, RUL can be interpreted as an estimation of the amount of time before a system is to be repaired or replaced.

In one use-case example, target system 204 can be a lithium-ion battery, and system 200 can apply hybrid reasoning to predict an end of discharge time. The discharge process follows a fundamental degradation mode (a in FIG. 1B). During the operation of the lithium-ion battery, as time progresses the voltage discharge progression can drop to approximately to a cutoff voltage of 2.8 V. For illustrative purposes, the battery data obtained from the public prognostics data repository at NASA Ames, the batteries were charged up to about 4.2 V by an initial constant current profile of 1.5 A until 4.2 V is reached. It is followed by a constant voltage mode until the charge current drops to 10 mA. For discharge experiments, constant electric current load of 2 A was used. At fully discharged condition (100% charge depletion) batteries voltage reached 2.8 V.

Sensor signal measuring module 210 can measure and record sensor signals that can be represented as cycle measurements of terminal current, voltage, cell temperature, and cycle to cycle measurements of capacity. Sensor data processing module 212 can perform data scrubbing and feature extraction operations System 200 can store the pre-processed data in a machine readable and compact format for further computational operations. Hybrid model 214 can represent the fundamental degradation mode. Prediction module 220 can predict the fault progression (here the discharge progression) and end-of-life time (here end of discharge time) based on the hybrid reasoning and evolving the degradation model through time.

FIG. 3 illustrates different data processing techniques, in accordance with an embodiment of the present application. In the example shown in FIG. 3, data processing module 302 (shown as sensor data processing module 212 in FIG. 2) can perform different data processing operations. For example, data scrubbing 304 can fill in missing data, remove outliers, and smoothen the noisy data. Data processing module 302 can perform data fusion 306 to compile data received from different sources to increase the probability of information condensation. Data transformation 308 operation can normalize and aggregate the assembled data. In some domains, e.g., lithium-ion batteries, the degradation progression trajectory and root cause fundamental mode can be obtained directly from the sensor data. However, in some domains degradation progression information and damage variable are not directly observable. In such cases, indirect inference from data can be performed. Accordingly, data are processed and mapped to a health domain in which a health indicator can be reconstructed with the highest correlation with the fundamental degradation modes. As mentioned earlier, with the aim of appropriate integrating the physics and machine learning a degradation mode may be separated into different phases. Also, the transition of these phases can be identified. In the case of fundamental mode α, three different phases can be considered. The transition from the quasi-linear phase to the exponential phase is called the elbow point. Accordingly, detection of the elbow point is applied on the health indicator for finding the equivalent degradation phases. Constructing such a health indicator may need further processing as well given the domain of applications. For example, in a system with clustered modes of operations, data processing module 302 can perform data scrubbing operation 304 followed by clustering the modes of operation by a clustering algorithm such as K-means, then normalization based on each cluster.

Data reduction operation 310 can decrease the size of data by removing the non-informative data and features to reduce computational complexity, information redundancy, and save the computational resource.

For example, in the use case of a commercial modular aero-propulsion system simulation (C-MAPSS) dataset, which contains simulated run-to-failure trajectories of a fleet comprising large turbofan engines (second illustrative case study of this invention) and which was obtained from the public data repository at NASA Ames Research Center, twenty-one sensor signals can be reduced to eight sensor signals based on prognosability, trendability, and monotonicity measures.

Data discretization 312 operation can transfer continuous data to a discrete space, in which data can be represented by a finite set of numbers. Feature extraction 314 operation can extract certain aspects of the sensor signals that are robust, correlated, informative (e.g., extracting information about the target of a mapping algorithm). For example, in the case of C-MAPPS since the degradation variable is not directly observable a health index varying in a health domain can be constructed by data processing and specifically feature extraction. Then, high-dimensional sensor data are mapped to this single dimensional health domain, i.e., features extracted from the eight sensor signals (obtained after data reduction operation) may follow a degradation pattern that is correlated and reasonably similar to the generic fundamental degradation mode 100.

Feature ranking operation 316 can measure the importance of certain features, and feature sensitivity operation 318 can measure robustness of a feature against probable changes in data distribution. Based on specific characteristics of each domain of application and observed data, a certain set of data operations from 304-318 can be selected, customized, and implemented. The hybrid reasoning system may apply data processing module 302 to process sensor data and use the processed sensor data for performing prognosis about the health of the target system.

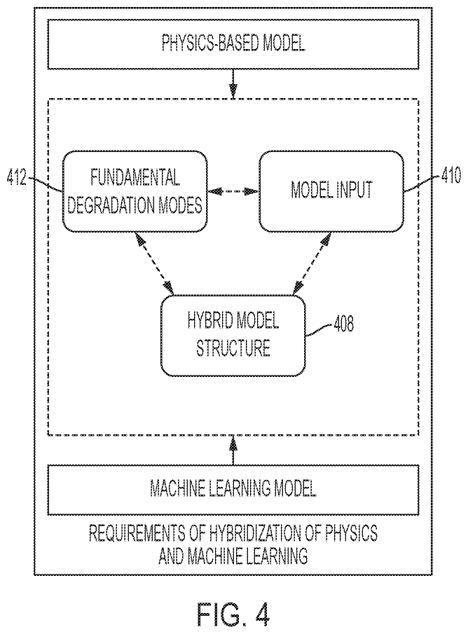

FIG. 4 illustrates requirements of hybridization of physics and machine learning, in accordance with an embodiment of the present application. Component 412 represents fundamental degradation modes in a target system and emphasizes that essence of hybridization of physics and machine learning is representation of fundamental degradation modes.

Component 410 can represent inputs of hybrid degradation model. When the inputs are invariant and robust to those changes which are irrelevant to fault progression, the transferability of the degradation model can be improved. It is desired that the inputs be correlated with the fault progression so that the inputs can provide some information about the degradation progression with least possible variations. This means that the inputs can correspond to features extracted from commonalities of degradation progression rather than specifications. For example, the transferable hybrid reasoning system may select features that are informative for predicting the degradation progression and that are least sensitive or robust to changes. In other words, the transferable hybrid reasoning system can first extract features from monitored sensor signals and upon initial data processing rank the extracted features based on the relevance of each of the features. The system can measure and determine a number of aspects that statistically quantifies the relevance of each of the features, e.g., prognosability, trendability, and monotonicity. Further, the system can measure the robustness of the features to using statistical measures such as coefficient of variation.

Component 408 shows that hybridization of physics and machine learning can be independent of specifications of a domain of application. An ideal model is expected to be independent of the characteristics of degradation pattern of a specific target system. For example, a quasi-linear phase in the a fundamental degradation mode can be of different time scales in different domains, however, it is desirable that the system can identify, observe, analyze and follow this phase continuously regardless of its time length or duration.

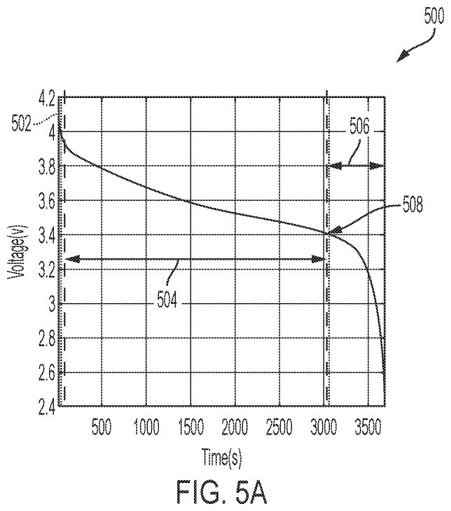

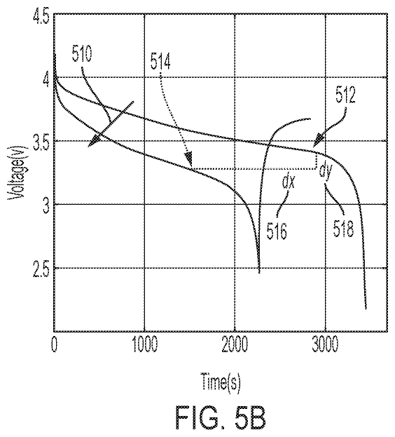

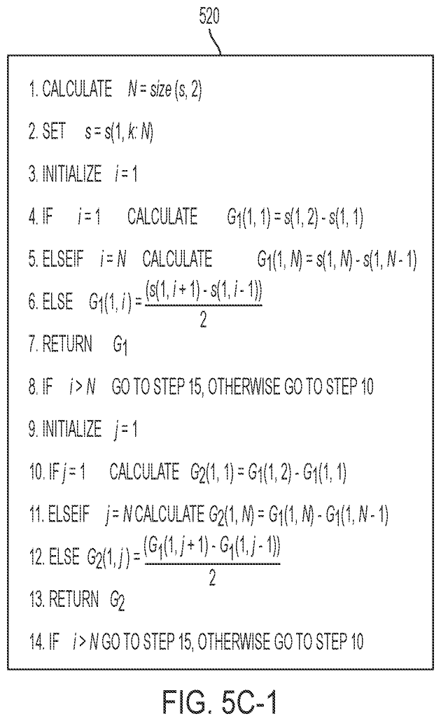

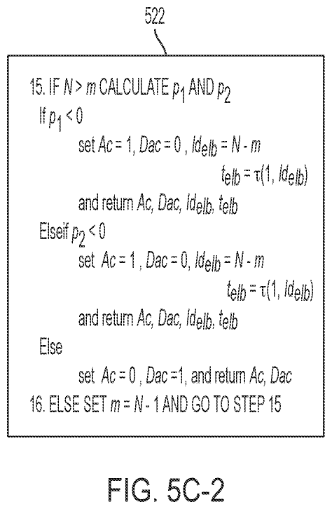

FIG. 5A shows a first use case that represents the exemplary discharge trajectory of a lithium-ion battery which follows a fundamental degradation mode, in accordance with an embodiment of the present application. Also, the corresponding phases are noted on this figure. FIG. 5A shows a plot 500 of a discharge trajectory for lithium-ion battery which includes an initial transient degradation phase 502, a quasi-linear degradation phase 504, and an accelerated degradation phase 508. Initial degradation phase 502 represents an initial or a preliminary voltage drop that is followed by the second degradation phase 504 which represents a slow quasi-linear degradation (discharge). The last degradation phase 506 can be accelerated comparing with the first one. A transition point between the second phase 504 and third phase 506 represents an elbow point 508. Elbow point 508 indicates the start of accelerated phase 506 towards an end-of-life threshold.

The physics-based model can accurately follow and extrapolate the second phase since degradation is quasi-linear. Identifying the transition of these phases is critical as well. In one embodiment, the system can implement an elbow point detection algorithm to detect an elbow point on the degradation progression for the target system. The system can selectively trigger the operation of the physics-based model during the quasi-linear phase 504 and until the elbow point is detected. In response to detecting the elbow point, the system can then trigger the operation of the machine learning model after detecting the elbow point, i.e., in accelerated phase 506.

FIG. 5B shows two exemplary discharge trajectories over two load cycles for a lithium-ion battery that can be representative of fundamental degradation mode 100, in accordance with an embodiment of the present application. In the example shown in FIG. 5B two discharge trajectories over two different load cycles for a lithium-ion battery are shown. Capacity fade 510 can indicate aging of the lithium-ion battery over consecutive charge and discharge cycles. Elbow points 512 and 514 can represent the transitions points on respective discharge trajectories. In one embodiment, the transferable hybrid reasoning system can extract a horizontal displacement 516 value (dx) and a vertical displacement 518 value (dy) between elbow points, e.g., 512 and 514, as feature candidates.

FIG. 5C illustrates an algorithm for detecting an elbow point in a degradation trajectory in accordance with an embodiment of the present application. In the example shown in FIG. 5C, the elbow point detection algorithm can perform two sets of relevant operations, lines 1 to 13 (block 520 in FIG. 5C) can correspond to a first set of operations and lines 14-15 (blocks 520 and 522 in FIG. 5C) can be the second set of relevant operations.

The first set of operations (lines 1-13) can calculate a first order gradient (G₁) and a second order gradient (G₂) for the observed sensor data of health indicator denoted by observation vector (s) using a central difference method. The term N can denote number of elements in the observation vector, s. Since the initial degradation phase lasts for a short period, the elbow detection algorithm can include a skip factor k to avoid these initial observations. In other words, the skip factor k is integrated into algorithm (line 2 in FIG. 5C) to skip the initial transient observations at the start of loading the target system.

In the second set of operations (lines 14-15), the elbow detection algorithm can include operations to find, based on the observation vector, a point in time where a negative gradient starts and the gradient continues to remain negative for a certain observation period or a certain number of observations, m. This observation period or imposed delay can confirm the continuity of the detected negative gradient and hence can indicate the degradation transition from the slow-quasi degradation phase to an accelerated degradation phase. Further, the second set of operations (lines 14 to 15) can calculate, based on a gradient vector, an elbow point index, an elbow point time, and whether the target system is in the accelerated phase (Ac=1, Dac=0) or the slow phase (Ac=0, Dac=1).

The system can implement the elbow detection algorithm shown in FIG. 5C with inputs including an observation vector s, an initial observation skip k, an observation time vector τ, and an observation vector delay size m. In response to implementing the elbow detection algorithm, the system can output a vector containing the first gradient G₁, a vector containing the second gradient G₂, an index in time vector showing the elbow point (Id_{elb}), elbow point time t_{elb}, accelerated phase of degradation Ac index and slow phase of degradation index Dac.

### Physics-Based Model

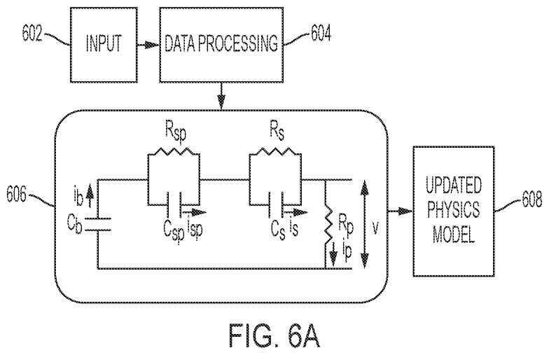

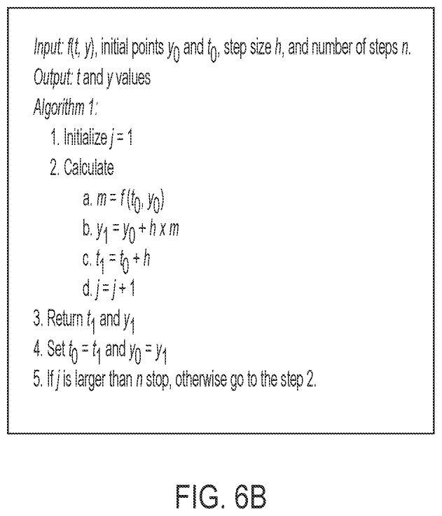

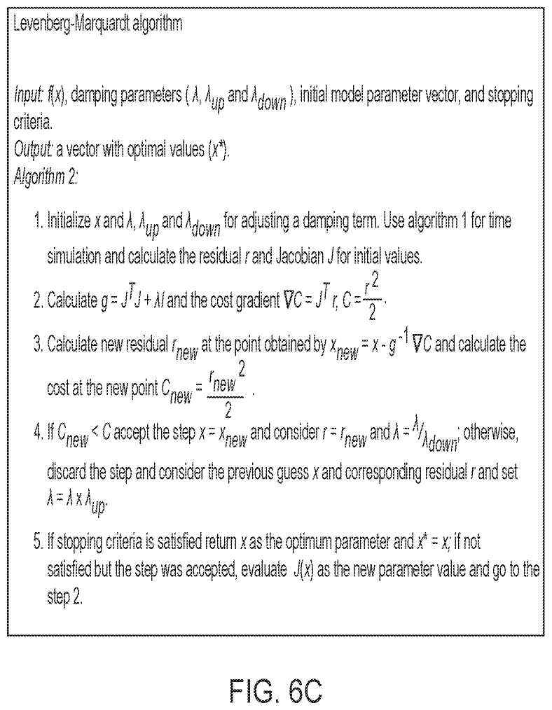

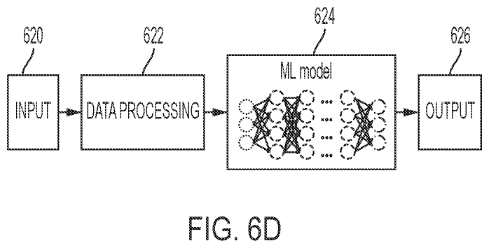

FIG. 6A presents an exemplary physics-based model prognosis reasoning, in accordance with an embodiment of the present application. In the example shown in FIG. 6A, details of using physics for abstraction of the quasi-linear phase of degradation is illustrated. In FIG. 6A, an empirical model 606 is used that parametrizes the degradation pattern using each run to failure trajectory. Empirical model 606 can represent the degradation in a mathematical framework in which the inputs are processed sensor data (from data processing operation 604) and the output is a physics inspired model 608 that can be used for time simulation and obtaining a health indicator value. The system can perform data processing operations 604 on sensor signals observed over a number of loading cycles.

In order to provide a balance between complexity and accuracy, for this case of lithium-ion battery, the system can apply an electrical circuit model (ECM) 606 as a special family of empirical models. ECM can include equivalent electrical components and empirical equations. The system may obtain ECM 606 parameters based on the measured data from observations. ECM 606 may correspond to a lithium-ion battery.

In the example ECM 606 for a lithium-ion battery, a large capacitance C_{b} may keep charge q_{b} of the lithium-ion battery. The non-linear C_{b} can capture the open circuit potential and concentration overpotential. The Rₛₚ−Cₛₚ pair can represent a non-linear voltage drop given the surface overpotential, Rₛ can capture the ohmic drop, and Rₚ stands for the parasitic resistance representing self-discharge.

For ECM 606, a state of the charge (SOC) can be denoted as:

$$SOC = 1 - \frac{{q}_{max} - {q}_{b}}{{c}_{max}} \qquad ( 1 )$$

where q_{b} indicates the current charge in the battery, qₘₐₓ is the maximum possible charge or discharge capacity, and Cₘₐₓ is the maximum possible capacity. The surface overpotential can be denoted as a function of SOC:

Rₛₚ=Rₛₚ_{₀}+Rₛₚ_{₁} exp(Rₛₚ_{₂}(1−SOC)) (2)

where Rₛₚ_{₀}, Rₛₚ_{₁} and Rₛₚ_{₂} are empirical parameters.

Voltage drop across the individual circuit components can be given by:

$${V}_{b} = \frac{{q}_{b}}{{c}_{b}} \qquad ( 3 )$$

$${V}_{sp} = \frac{{q}_{sp}}{{c}_{sp}} \qquad ( 4 )$$

$${V}_{s} = \frac{{q}_{s}}{{c}_{s}} \qquad ( 5 )$$

$${V}_{p} = {V}_{b} - {V}_{sp} - {V}_{s} \qquad ( 6 )$$

where qₛₚ represents the charge corresponding to capacitance Cₛₚ, qₛ is the charge associated with Cₛ, and V_{b} corresponds to the open-circuit voltage. C_{b} can be written as a function of SOC, i.e., C_{b}=C_{b0}+C_{b1}SOC+C_{b2}SOC²+C_{b3}SOC³. The voltage, V, of the battery is given by V=V_{b}−Vₛₚ−Vₛ. Current associated with each element and their corresponding charges are summarized in Table 1 below.

TABLE 1
Current and charge associated with each element in ECM 608

| Current | Charge |
|---|---|
| ${i}_{b} = {i}_{p} + i ; {i}_{p} = \frac{{V}_{p}}{{R}_{p}}$ | \dot{q}_{b} = −i_{b} |
| ${i}_{sp} = {i}_{b} - \frac{{V}_{sp}}{{R}_{sp}}$ | \dot{q}_{sb} = iₛₚ |
| ${i}_{s} = {i}_{b} - \frac{{V}_{s}}{{R}_{s}}$ | \dot{q}ₛ = iₛ |

Given the above set of equations, the parameters of ECM 608 can be denoted in a set as

Mₚ={C_{b0},C_{b1},C_{b2},C_{b3},Rₛ,Cₛ,Rₚ,Cₛₚ,Rₛₚ₀,Rₛₚ₁,Rₛₚ₂,qₘₐₓ Cₘₐₓ}

The physics-based modeling system may obtain ECM 606 parameters by minimizing the deviation between the simulation data and observed data (available in a dataset). The minimization can be defined as:

min f(x)=Σᵢ₌₁^{m}(Vₘ(tᵢ)−Vₛ(x,tᵢ))² (7)

where x∈R t∈[tₛ t_{f}]. With x denoting the model parameters' vector and f(x) represents the sum of square of deviations in m data points between simulated voltage data Vₛ(x, t) and the measured voltage data Vₘ(t). Time t changes in a range with lower band tₛ and upper band t_{f}, where tₛ and t_{f} show the start and end time of minimization in each loading cycle, respectively.

The system modeling the physics-based model may calculate the simulated voltage discharge (Vₛ(t)) by transferring the charge related equations in Table 1 to a state space with states y=[q_{b}, q_{sb}, qₛ] and solving an algorithm shown in FIG. 6B with a state update function of f(t, y).

FIG. 6B illustrates an algorithm for determining a numerical solution of a state space representation of a physics-based model, in accordance with an embodiment of the present application. The system modeling the physics-based model may apply algorithm shown in FIG. 6B to determine a numerical solution for state space representation of physics-based model equations (i.e., first order ordinary differential equations) and to calculate a simulated discharge voltage of the battery (Vₛ(t)).

Further, to solve the minimization problem, equation (7) can be written as:

Σᵢ₌₁^{m}(Vₘ(tᵢ)−Vₛ(x,tᵢ))²=Σᵢ₌₁^{m}Fᵢ²(x) (8)

The term F(x) can be denoted as

$$F ( x ) = ⌈ \begin{matrix}{V}_{s} ( {t}_{1} ) - {V}_{m} ( x , {t}_{1} ) \\ {V}_{s} ( {t}_{2} ) - {V}_{m} ( x , {t}_{2} ) \\ ⋮ \\ {V}_{s} ( {t}_{m} ) - {V}_{m} ( x , {t}_{m} )\end{matrix} ⌉ \qquad ( 9 )$$

Jacobian matrix of F(x) is denoted by J(x) and gradient of f(x) is G(x). The minimization problem is solved by Levenberg-Marquardt algorithm (LMA). This method for finding optimal values of the parameter vector x shown by x* uses a search direction that is given by solution δ to the following equation,

(J^{T}J+λI)δ=J^{T}r (10)

with λ a non-negative damping parameter, I is an identity matrix, and r denotes a residual vector. FIG. 6C illustrates the Levenberg-Marquardt algorithm for solving a minimization problem, in accordance with an embodiment of the present application. The system may apply the LMA shown in FIG. 6C to solve the minimization problem in an iterative process starting from a set of initial values.

In each cycle of loading, during the minimization process, the system may retune the optimal values for model parameters in Mₚ that makes the physics-based model's time simulation outputs fitted on corresponding cycle's measured voltage discharge data (Vₛ(x, tᵢ)).

In one embodiment, where the damage variable and degradation progression are not directly observable and physics of degradation progression is partially known, a health indicator is extracted that is correlated to the fundamental degradation mode 100. This indicator is used for prognostics of turbo-fan engine that is the second case study of the current invention. This health indicator can be assumed as abstract of physics of degradation and its progression. Accordingly, the variation of this index in the reconstructed health domain is considered for analyzing the fundamental mode and phases. To this end, the variation of health indicator in the health domain is mathematically formulated.

Degradation progression (D(x)) in the health domain can be represented with an empirical model and degradation progression can be formulated as:

D(x)=ae^{bx}+ce^{dx} (11)

where a, b, c, and d are constants that can be obtained from the sensor data. The term, x denotes the load cycles. The deviation between model simulation and observations can be minimized by a non-linear least square method that uses the trust region algorithm.

The physics-based model can also be used to construct the health domain by filtering out degradation trajectories that are less representative of the fundamental degradation mode. A system can perform such a filtering process by analyzing the sign of the empirical model parameters (a, b, c and d) after fitting on each trajectory over a loading time. When the parameters [a, c] are positive, and [b, d] are negative, the corresponding trajectory is dropped. The selected trajectories can be used as representative of fault progression trajectory in a single dimensional health domain. Further, a min-max scaling can be performed to transform data to a scaled range of [0, 1] which its upper and lower bounds respectively represent healthy and end of life condition.

### Machine Learning Model

FIG. 6D presents an exemplary machine learning model to be deployed in the accelerated degradation mode, in accordance with an embodiment of the present application. The example shown in FIG. 6D demonstrates a machine learning model 624 that can provide a mapping between an input and an output. Input 620 can be sensor signal information or voltage time change for a lithium-ion battery. The system may perform data processing operations 622 on the monitored sensor signals. Output 626 of machine learning model 624 can provide information about discharge progression.

Given the non-linearity of the mapping between input 620 and output 626 of machine learning model 624, an artificial neural network in the form of a multi-layer perceptron can represent the machine learning model (and other machine learning models can also be used). In one embodiment of the application, machine learning model 624 can be an artificial deep neural network in the form of multi-layer perceptions. The input for model 624 can be a set of features which are invariant and informative about fault progression and degradation.

In some domains such as turbo-fan engines, the health domain with fundamental degradation modes may not be directly observable from sensory data, so several additional steps of data processing are required. Data processing transforms the sensor data to a health domain which is defined by its high correlation with fundamental degradation modes. The elbow point detection accordingly is applied on the health indicator in this space for finding the equivalent fundamental degradation mode and corresponding phases. Constructing such a health domain may need further processing as well given the domain of applications. For example, in a system with clustered modes of operation, data processing module 302 can perform data scrubbing operation 304 followed by clustering the modes of operation by a clustering algorithm such as K-means then normalization/scaling based on each cluster. Also, given the amount of knowledge on physics of the system a mathematical model representing the health variation in the health domain maybe considered similar to equation 11.

Data processing module 622 can measure and rank the information content of features candidates as the models' inputs based on prognosability, trendability, and monotonicity. Further, data processing module 622 may measure the sensitivity/robustness of these features to changes by evaluating their coefficient of variation. For example, data processing module 622 may select a subset of features that are most informative of the degradation and fault progression with minimum variation. The subset of features can include kurtosis skewness, first derivative, second derivative, peak to root mean square (RMS), entropy, energy, mean, elbow point vertical displacement dx and horizontal displacement dy (shown in FIG. 5B), and recurrence quantification analysis (RQA) features, and can also include other time, frequency, and time-frequency features.

The RQA features that are most informative about degradation progression and are robust to statistical changes can include recurrence rate (RR), laminarity (LAM), and entropy (ENT).

Machine learning model 624 can be an artificial neural network. For setting the neural network, hyper parameters optimization is performed by grid search with the following search space of hyperparameters: number of hidden layers can be in the range [1,6], number of neurons at each hidden layer can be in the range [10,30], and activation function type can include [tanh, ReLu, sigmoid]. The final neural network can have one input layer, three hidden layers, and one output layer. The hidden layers activation and output layer activation functions can be sigmoid and linear, respectively.

Model 624 may set the initial values of weight and bias randomly and can update them according to Levenberg-Marquardt method. In one example implementation of model 624, the number of neurons in hidden layer connected to input layer can be thirty and the number of neurons connected to output layer can be twenty, output layer can have a single neuron. In one embodiment, data can be randomly separated for training, validation, and testing, e.g., 60% of data for training, 15% of the data for validation, and 25% of the data for testing (other ratios of data separation are also possible). The number of neurons in the input layer is based on the number of input variables (here they are nine). The stopping criteria can be maximum validation failures (e.g., 10) and performance gradient can be, e.g., 1e-7.

A training system may train machine learning model 624 to predict the discharge progression and will be used by the physics-based model to predict the entire discharge trajectory.

### Hybrid Physics-Based Model and Machine Learning Model

A hybrid the physics-based model (PBM) and the machine learning model can combine the advantages provided by both the models without compromising on transferability/adaptability to estimate the remaining useful life. The PBM can provide a generic and robust representation of a degradation progression for a target system given enough data from each mode of degradation. The PBM can be data-efficient in representing the slow quasi-linear phase since the fault progression is quasi-linear. In other words, the PBM can follow the degradation progression trajectory in the quasi-linear degradation phase independent of the time scale. Therefore, the hybrid model may apply the PBM in the quasi-linear degradation phase.

On the other hand the machine learning model can follow the accelerated degradation phase with improved accuracy when compared to the PBM. The hybrid model can use the information about the accelerated degradation phase from the machine learning model to enhance the performance of the PBM. The outputs of the machine learning model are used by PBM in predicting the entire degradation trajectory. The inputs of the machine learning model can be features that are extracted according to the requirements of robustness and relevance for the prognostics task.

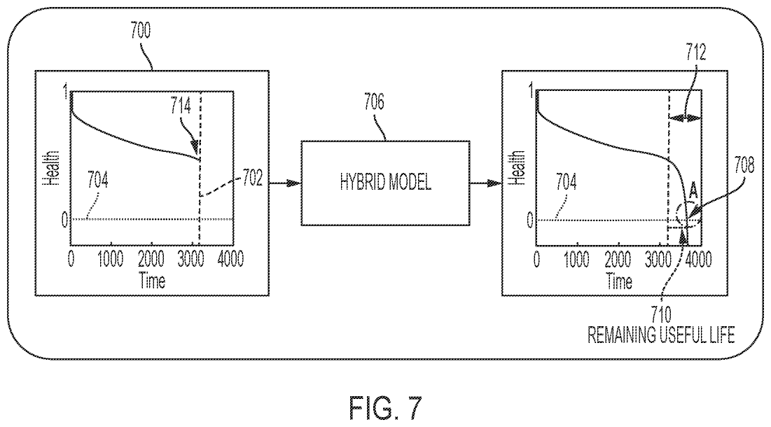

FIG. 7 shows an exemplary hybrid prognosis reasoning for predicting a degradation trajectory and estimating a remaining useful life of a target system, in accordance with an embodiment of the present application. In response to detecting the start of the accelerated degradation phase or upon detecting an elbow point 714, a hybrid model 706 can start predicting the degradation trajectory (shown in region 712). Based on the predicted degradation trajectory and its intersection 708 with an end-of-life threshold 704, hybrid model 706 can estimate a remaining useful life 710 of the target system.

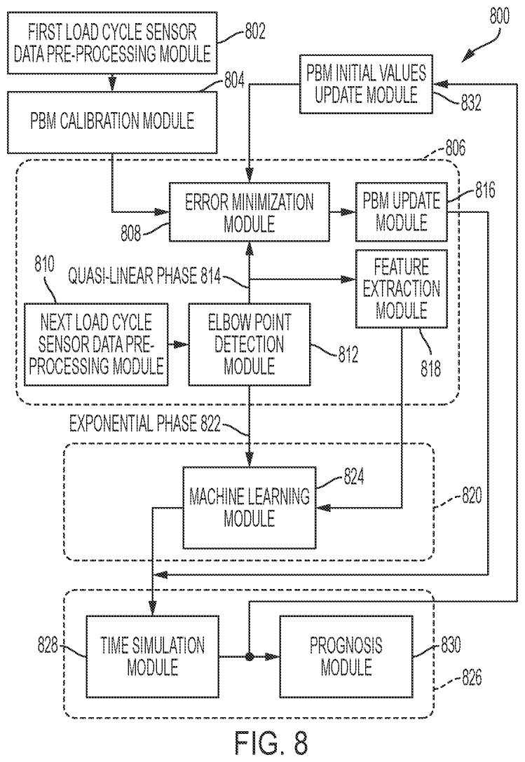

FIG. 8 illustrates an exemplary hybrid reasoning system architecture with mutual coupling between physics-based model and machine learning model, in accordance with one embodiment of the present application. In the example shown in FIG. 8, hybrid reasoning system 800 can provide a mutual connection between the physics-based model and machine learning model to estimate the health of the target system. Specifically, system 800 may update physics-based model parameters based on quasi-linear and accelerated phases. More specifically, system 800 may perform parameter update based on limited data associated with the quasi-linear phase of degradation (e.g., quasi linear region in voltage discharge when lithium-ion battery is used as the target system) and based on machine learning model predictions on discharge progression in the accelerated phase.

Hybrid reasoning system 800 can include a number of different operations which can be grouped into different phases of operation. For example, in a first phase of operation PBM calibration module 804 can calibrate a PBM based on data corresponding to the first discharge cycle from a first load cycle sensor data pre-processing module 802. Specifically, PBM calibration module 802 may use the measured voltage data related to one full discharge trajectory for the first discharge cycle (n=1) to calibrate the PBM. Module 804 may generate a calibrated PBM with a set of initial values for the PBM parameters.

In an example second phase (e.g., in FIG. 8, modules operating in the second phase are included within a dashed rectangle block 806), system 800 can perform further calibration of the PBM by applying an error minimization module 808 to minimize an error between the PBM time simulation outputs and observation (measured discharge voltage) data over the first discharge cycle. Specifically,

min h(x)=Σᵢ₌₁^{m}(Vₘ(tᵢ)−Vₛ(x,tᵢ))² (12)

where x∈R, t∈[0 t_{c}], x denotes the PBM parameters' vector and h(x) the sum of square of deviations in m data points between simulated voltage data Vₛ(x, tᵢ) and measured voltage data Vₘ(tᵢ). Time, tᵢ, changes in a range with lower band “0” and upper band t_{c}. This time range [0, t_{c}] can show the start and end time of calibration in the first loading cycle (n=1), respectively. Vₛ(x, tᵢ) represents the simulation result and Vₘ(tᵢ) denotes the measured observations. System 800 may apply LMA (shown in FIG. 6C) to solve this minimization problem in an iterative process to provide the model parameters for the first discharge cycle according to algorithm shown in FIG. 6B.

Further, in the second phase (806), as the target system, e.g., lithium-ion battery, undergoes a next loading cycle (n>1) system 800 can start receiving sensor data from module 810. System 800 may apply elbow point detection module 812 to the sensor data in the next loading cycle to determine an elbow point for separating the degradation mode into an accelerated phase and a slow quasi-linear degradation phase. Elbow point detection module 812 can implement the elbow point detection algorithm shown in FIG. 5C. To ensure that an initial transient degradation phase is skipped and to confirm continuity of a negative gradient on the degradation trajectory, the skip parameter and the parameters that indicates a certain number of observations in which the gradient continues to remain negative are set as k=30 and m=20.

As system 800 receives sensor data from the next load cycles, i.e., sensor data output by module 810, elbow point detection module 812 can observe the degradation data online and can determine the current active phase. In other words, elbow point detection module 812 in addition to determining an elbow point may serve as an online observer for identifying the rate of degredation progression and a corresponding phase.

In response to elbow detection module 812 determining that the fault or degradation of the target system is propagating in the slow quasi-linear phase, system 800 may perform two different tasks. First, system 800 may continue operation along the path indicated by 814 until module 812 detects an elbow point. Second, system 800 can update the PBM parameters sequentially over time. During each update, system 800 can apply module 810 to perform data pre-processing operations on the sensor signals and system 800 may apply the pre-processed sensor data to update the PBM parameters. Data pre-processing operations may include data scrubbing for smoothening the data for noise removal, data reduction, and data fusion. System 800 may update the PBM by minimizing the deviation between time simulation data and observation data. Error minimization module 808 may perform error minimization and find the values for the PBM parameters based on equation (7). Through this error minimization, system 800 can solve the state space representation of the physics-based model using the algorithm shown in FIG. 6B from time zero to of the first prediction time.

System 800 can continue feature extraction and apply feature extraction module 818 to select robust and degradation sensitive features from the sensor signals. In response to system 800 determining that an elbow point has been detected, system 800 may apply the extracted features (from module 818) and the updated PBM (from module 816) to an example third phase of operations. The modules operating in the third phase of operations are included in the dashed rectangle 820.

In the example third phase, elbow detection module 812 has already detected the elbow point to indicate activation of accelerated degradation phase that drives the target system towards an end-of-life. In other words, in response to elbow detection module 812 detecting the elbow point, system 800 may provide the pre-processed sensor data (i.e., sensor data in the exponential or accelerated mode is provided as input 822) and extracted features from module 818 is also provided as input to a machine learning module 824. Machine learning module 824 can, based on the inputs, predict the degradation progression.

As already explained that the PBM can follow the slow quasi-linear degradation phase, but it would have poor performance in the accelerated degradation phase. In one embodiment, system 800 may inform the PBM that the target system is in the accelerated phase. For example, when elbow detection module 812 detects the elbow point, system 800 may proceed to operations starting along path 822 instead of path 814.

In an example fourth phase 826, system 800 may predict the entire degradation trajectory and perform prognosis. Specifically, system 800 upon updating the physics-based model using predictions of 824 may apply time simulation module 828 to perform time simulation of the PBM based on numerical solution of the state space representation of physics-based equations according to algorithm shown in FIG. 6B. Based on such a time simulation, time simulation module 828 may predict a full discharge trajectory.

System 800 may then apply a prognosis module 830 to perform prognosis reasoning for identifying an intersection of the predicted discharge trajectory with end of discharge voltage threshold (e.g., about 2.8 V) and for predicting an end of discharge time. The difference between the predicted end of discharge time and the current time may indicate the remaining time before full charge depletion.

In addition, system 800 may apply the output of time simulation module 828 to update PBM model parameters using PBM initial values update module 832. Furthermore, system 800 may provide the PBM parameters output by module 832 to an algorithm (shown in FIG. 6B) so that the updated initial values may be used as new initial values for the next discharge cycle (n>1). In other words, system 800 may initiate the update of the PBM with a set of parameters obtained from the calibration (in module 804) in the first discharge cycle (n=1). In the next cycles (n>1), system 800 may start with the updated parameters obtained from the previous cycle (n−1), i.e., from PBM initial values update module 832. Therefore, by optimally integrating the PBM and the machine learning model, system 800 can accurately predict the end of discharge time and estimate the remaining useful life of the target system.

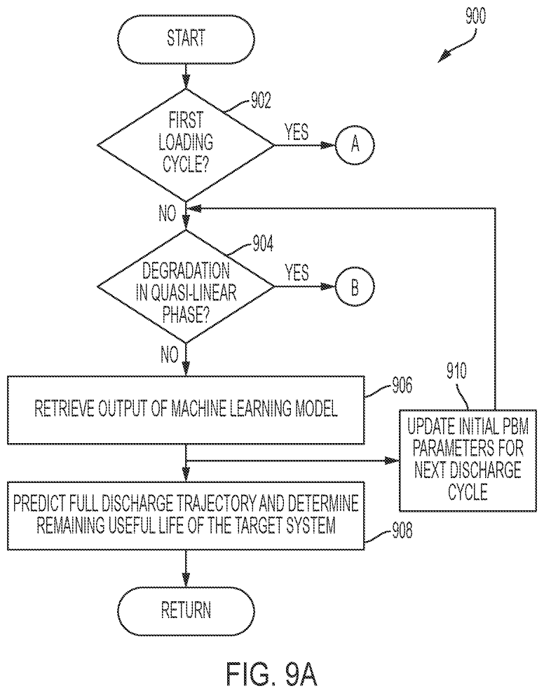

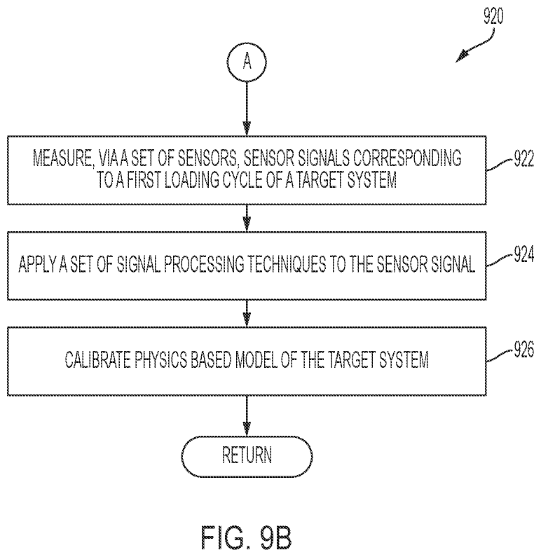

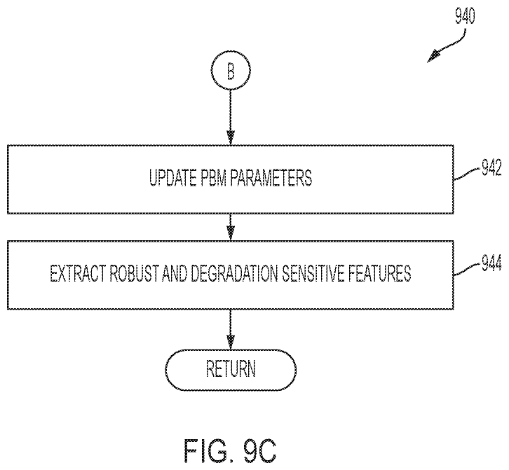

FIGS. 9A-9C present a flowchart illustrating a process for performing hybrid reasoning based on physics and machine learning for prognostics, in accordance with one embodiment of the present application. Lithium-ion battery is used as an example target system for explaining the flowchart in FIGS. 9A-9C. The hybrid reasoning system can be applied to other types of target systems that have a similar degradation pattern shown in FIG. 1. Referring to flowchart 900 in FIG. 9A, during operation, the hybrid reasoning system may determine whether the target system is in the first cycle of discharge loading (n=1) (operation 902). When the condition in operation 902 is satisfied, the system may calibrate the PBM (at label A which is described in reference to FIG. 9B).

When the condition in operation 902 is not satisfied, i.e., n #1, the system may determine whether the degradation progression of the target system is in a quasi-linear degradation phase (operation 904). When the system determines that the target system is in the quasi-linear degradation phase, the system may perform a set of operations (at label B which is described in reference to FIG. 9C). Specifically, the system may apply an elbow point detection algorithm (shown in FIG. 5C) to determine transition of degradation to the accelerated phase. For example, the system may apply the elbow point detection algorithm with k=30 and m=20 for separating and finding the fundamental degradation modes based on the features extracted from the sensor data (these features can be indicators of health of the target system). Given the probable noise in sensor data, it is desirable to smoothen some degradation trajectories, so the elbow point is detected with the second gradient in the elbow detection algorithm (shown in FIG. 5C). Until the target system is in the quasi-linear degradation phase (which is determined by applying the elbow point detection algorithm), the system may implement operations at label B.

When the condition in operation 904 is not satisfied, i.e., the target system is in an accelerated degradation phase, the system may retrieve the output of a machine learning model (operation 906) and start the prediction. In other words, the system may apply a machine learning model to map the robust and degradation sensitive features (determined at label B) to an end of discharge point.

At operation 908 the system may perform time simulation based on the output of the machine learning model and the updated PBM to predict a degradation pattern for the target system (e.g., the voltage discharge trajectory when the target system is a lithium-ion battery) after the elbow point. In response to performing the time simulation, the system may use the most updated parameters of the PMB for updating the initial PBM parameters for the next discharge cycle (operation 910). In addition, the system may start performing prognosis reasoning by identifying an intersection of predicted voltage discharge profile with end of discharge voltage threshold (e.g., 2.8 V). In response to identifying this intersection, the system may determine a RUL of the target system (operation 908).

Flowchart 920 in FIG. 9B illustrates the operations at label A shown in FIG. 9A. Specifically, in response to determining that the target system is in the first loading, i.e., first discharge cycle loading for lithium-ion battery (operation 902 in FIG. 9A), the system may measure, via a set of sensors associated with the target system, sensor signals corresponding to the first loading cycle of the target system (operation 922). The system may then start applying a set of signal processing techniques to the sensor signals, e.g., prior to setting the initial parameter values of PBM (operation 924). Based on the processed sensor data, the system may calibrate the PBM of the target system (operation 926).

Flowchart 940 in FIG. 9C illustrates the operations at label B shown in FIG. 9A. Specifically, in response to determining that the degradation progression of the target system under operation is in the quasi-linear degradation phase, (operation 904 in FIG. 9A), the system may update the PBM parameters (operation 942). The system may then start extracting robust and degradation sensitive features from the pre-processed sensor data (operation 944). The system may provide these features as input to the machine learning model over the accelerated degradation mode, i.e., after the system detects an elbow point in the degradation progression of the target system.

### Exemplary Transferable Hybrid Reasoning Computer System

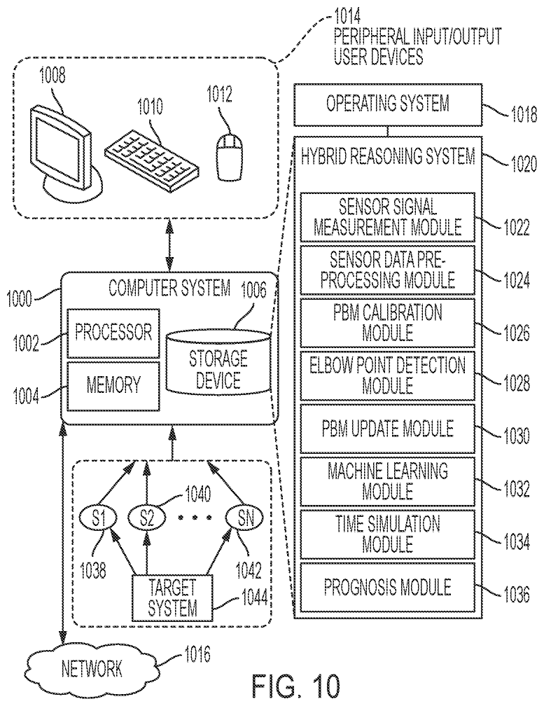

FIG. 10 illustrates an exemplary computer system that facilitates hybrid reasoning based on physics and machine learning for prognostics, in accordance with one embodiment of the present application. Computer system 1000 includes a processor 1002, a memory 1004, and a storage device 1008. Memory 1004 can include a volatile memory (e.g., RAM) that serves as a managed memory, and can be used to store one or more memory pools. Furthermore, computer system 1000 can be coupled to peripheral input/output (I/O) user devices 1014, e.g., a display device 1008, a keyboard 1010, and a pointing device 1012, and can also be coupled via one or more network interfaces to a network 1016. Computer system 1000 can be coupled to a target system 1044 via one or more network interfaces and can also communicate with a set of sensors 1038-1042. Storage device 1006 can store instructions for an operating system 1018 and a hybrid reasoning system 1020.

In one embodiment, hybrid reasoning system 1020 can include instructions, which when executed by processor 1002 can cause computer system 1000 to perform methods and/or processes described in this disclosure. Hybrid reasoning system 1020 can include a sensor signal measurement module 1022 for measuring and recording sensor signals from sensors 1038-1042 that are attached to a target system 1044 whose degradation pattern is to be predicted. Sensor signal measurement module 1022 can measure and record sensor signals about certain aspects of target system 1044. Hybrid reasoning system 1020 can further include instructions implementing a sensor signal/data pre-processing module 1024 for performing pre-processing on the sensor data before the sensor data is used for predicting the degradation pattern of target system 1044.

Hybrid reasoning system 1020 can include a PBM calibration module 1026, which can calibrate the PBM parameters based on the pre-processed sensor data from a first loading cycle (or discharge for lithium-ion battery). Hybrid reasoning system 1020 can further include instructions for implementing an elbow point detection module 1028 to determine an elbow point in the degradation progression of target system 1044. The elbow point can indicate that target system 1044 has transitioned from a slow quasi-linear degradation phase to an accelerated phase. In the quasi-linear degradation phase, the PBM can follow the degradation trajectory. Hence, as long as target system 1044 is in the quasi-linear degradation phase hybrid reasoning system 1020 can continue to update the physics-based model using PBM update module 1030. Hybrid reasoning system 1020 may also determine the robust features and degradation sensitive features.

In response to elbow detection module 1028 detecting an elbow point, hybrid reasoning system 1020 may implement a machine learning module 1032 for predicting degradation progression, based on sensor data in the accelerated degradation phase and the extracted robust and degradation sensitive features. Machine learning module 1032 may provide information regarding the accelerated phase of the target system to a time simulation module 1034 for simulating a degradation pattern for target system 1044, e.g., in the case of lithium-ion battery module 1034 may predict a voltage trajectory. Hybrid reasoning system 1020 may provide the predicted degradation pattern to PBM update module 1030 to update the PBM parameters.

In one embodiment, hybrid reasoning system 1020 may measure sensor signals from a next loading cycle and can pre-process the measured sensor signals using module 1022 and 1024, respectively. Machine learning module 1032 may inform the physics-based model about the accelerated degradation mode based on the pre-processed sensor data from the next loading cycle. Based on the improved estimate, PBM update module 1030 can update the PBM parameters associated with the accelerated phase of degradation. In one embodiment, machine learning module 1032 may apply incremental learning to predict the degradation progression.

Hybrid reasoning system 1020 can further perform error minimization between the PBM time simulation outputs and a set of observations in the current loading cycle. Based on this error minimization operation PBM parameters are updated.

Hybrid reasoning system 1020 can further include instructions to implement a time simulation module 1034 for simulating a degradation pattern for target system 1044, e.g., in the case of lithium-ion battery module 1034 may predict a voltage discharge trajectory. Prognosis module 1036 may use the predicted degradation pattern to determine a RUL about target system 1044, e.g., in the case of lithium-ion battery module 1036 may predict the end-of-discharge time and reaming time before the full charge depletion.

Therefore, hybrid reasoning system 1020 can integrate physics-based modeling techniques with data-based approaches. Hybrid reasoning system 1020 can provide a generic abstraction of the prognostics problem that can be generalized to other systems with similar degradation pattern.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method for estimating remaining useful life of a target system, comprising:
a degradation model that represents fundamental degradation modes shared in different domains of application.

2. The computer-implemented method of claim 1, further comprising:
a combination of physics-inspired evolution of the degradation modes towards a failure threshold; and
a data-driven mapping of features derived from sensor measurement into the degradation modes.

3. A computer-implemented method for estimating remaining useful life of a target system, the method comprising:
during operation of the target system, measuring, via a set of sensors associated with the target system, sensor signals;
in response to determining, based on the measured sensor signals, one or more fundamental degradation modes being active, extracting a set of features associated with the measured sensor signals and updating a physics-based model associated with the target system;
performing, based on machine learning model outputs, a time simulation of the updated physics-based model to predict a full degradation pattern of the target system; and
estimating, based on the predicted degradation pattern, a remaining useful life of the target system.

4. The computer-implemented method of claim 3, further comprising:
identifying fundamental degradation modes shared in different domains of application; and
using the identified shared fundamental degradation modes for transferring prognostics knowledge between the different application domains.

5. The computer-implemented method of claim 3, wherein an intersection of the predicted degradation pattern and an end-of-life threshold indicates a predicted end-of-life of the target system; and
wherein the remaining useful life of the target system corresponds to the difference between a current time and the predicted end-of-life of the target system.

6. The computer-implemented method of claim 3, wherein the set of features include a set of invariant features and a set of degradation sensitive features.

7. The computer-implemented method of claim 3, wherein the target system degrades over time, and wherein the target system includes one or more of:
a battery;
a power storage device;
a rotating machine;
a chemical plant;
an automotive component;
a biomedical component;
an aerospace component;
a nuclear power component;
a maritime component;
a mining component;
a medical equipment component;
a manufacturing system component;
a civil engineering related system; and
an electrical engineering related system.

8. The computer-implemented method of claim 3, further comprising: applying a set of signal processing techniques to the measured sensor signals to obtain pre-processed sensor data.

9. The computer-implemented method of claim 8, wherein the signal processing techniques include one or more of:
data scrubbing;
feature extraction;
feature sensitivity analysis;
feature ranking;
feature reduction or fusion; and
data transformation.

10. The computer-implemented method of claim 3, further comprising:
performing elbow point detection, based on the measured sensor signals, to determine a transition point on a degradation progression trajectory for the target system, wherein the transition point indicates a point at which the target system degradation transitions from a slow quasi-linear phase to an accelerated phase.

11. The computer-implemented method of claim 3, further comprising:
in response to determining, based on the measured sensor signals, that the target system is subject to a first loading cycle, calibrating a set of parameters of a physics-based model associated with the target system.

12. The computer-implemented method of claim 3, further comprising:
during a quasi-linear degradation phase of a fundamental degradation mode in the target system,
minimizing error between outputs of the time simulated physics-based model and measured sensor signals during a next cycle of loading of the target system;
generating, based on the error minimization, a new set of parameters; and
updating, based on the new set of parameters, the physics-based model.

13. A computer system, comprising:
a processor; and
a storage device storing instructions that when executed by the processor cause the processor to perform a method for estimating health condition of a target system, the method comprising:
developing a degradation model that represents fundamental degradation modes for the target system;
during operation of the target system, measuring, via a set of sensors associated with the target system, sensor signals;
in response to determining, based on the measured sensor signals, one or more fundamental degradation modes being active, extracting a set of features associated with the measured sensor signals and updating a physics-based model associated with the target system;
performing, based on machine learning model outputs, a time simulation of the updated physics-based model to predict a full degradation pattern of the target system; and
estimating, based on the predicted degradation pattern, a remaining useful life of the target system.

14. The computer system of claim 13, wherein the method further comprises:
identifying fundamental degradation modes shared in different domains of application; and
using the identified shared fundamental degradation modes for transferring prognostics knowledge between the different application domains.

15. The computer system of claim 13, wherein an intersection of the predicted degradation pattern and an end-of-life threshold indicates a predicted end-of-life of the target system; and
wherein the remaining useful life of the target system corresponds to the difference between a current time and the predicted end-of-life of the target system.

16. The computer system of claim 13, wherein the set of features include a set of invariant features and a set of degradation sensitive features.

17. The computer system of claim 13, wherein the target system degrades over time, wherein the target system includes one or more of:
a battery;
a power storage device;
a rotating machine;
a chemical plant;
an automotive component;
a biomedical component;
an aerospace component;
a nuclear power component;
a maritime component;
a mining component;
a medical equipment component;
a manufacturing systems component;
a civil engineering related system; and
an electrical engineering related system.

18. The computer system of claim 13, further comprising: applying a set of signal processing techniques to the measured sensor signals to obtain pre-processed sensor data.

19. The computer system of claim 18, wherein the signal processing techniques include one or more of:
data scrubbing;
feature extraction;
feature sensitivity analysis;
feature ranking;
feature reduction or fusion; and
data transformation.

20. The computer system of claim 13, further comprising:
performing elbow point detection, based on the measured sensor signals, to determine a transition point on a degradation progression trajectory for the target system, wherein the transition point indicates a point at which the target system degradation transitions from a quasi-linear phase to an accelerated phase.

21. The computer system of claim 13, further comprising:
in response to determining, based on the measured sensor signals, that the target system is subject to a first loading cycle, calibrating a set of parameters of a physics-based model associated with the target system.

22. The computer system of claim 13, further comprising:
during a quasi-linear degradation phase of a fundamental degradation mode in the target system,
minimizing error between outputs of the time simulated physics-based model and measured sensor signals during a next cycle of loading of the target system;
generating, based on the error minimization, a new set of parameters; and
updating, based on the new set of parameters, the physics-based model.
